(19) United States
(12) Patent Application Publication
(10) Pub. No.: US 2026/0012421 A1
(43) Pub. Date: Jan. 8, 2026

(54) TECHNOLOGIES FOR CONGESTION SIGNALING IN WIRELESS NETWORKS

(71) Applicant: Apple Inc., Cupertino, CA (US)

(72) Inventors: Ralf Rossbach, Munich (DE); Fangli Xu, Beijing (CN); Bobby Jose, San Diego, CA (US); Vijay Venkataraman, San Jose, CA (US); Srinivas Reddy Mudireddy, San Diego, CA (US); Haijing Hu, Los Gatos, CA (US); Ping-Heng Kuo, London (GB)

(73) Assignee: Apple Inc., Cupertino, CA (US)

(21) Appl. No.: 19/111,763

(22) PCT Filed: Sep. 29, 2022
(86) PCT No.: PCT/CN2022/122844

§ 371 Date: Mar. 13, 2025

(30) Foreign Application Priority Data
Sep. 23, 2022 (WO) PCT/CN2022/121030

(51) Int. Cl. H04L 47/11; H04L 47/26; H04W 28/02; H04W 76/20

(52) U.S. Cl. CPC H04L 47/115; H04L 47/26; H04W 28/0284; H04W 76/20

(57) ABSTRACT

The present application relates to devices and components including apparatus, systems, and methods for congestion signaling in wireless networks.

### TECHNICAL FIELD

This application relates generally to communication networks and, in particular, to technologies for congestion signaling in such networks.

### BACKGROUND

Low latency low loss scale throughput (L4S) is a technology based on an Internet Engineering Task Force (IETF) standardization. L4S provides high throughput and low latency for Internet protocol (IP) traffic that may result in improved, fast-radio adaption management and reduce network congestion, queuing, and packet loss.

### BRIEF DESCRIPTION OF THE DRAWINGS

FIG. 1 illustrates a network environment in accordance with some embodiments.

FIG. 2 illustrates the network environment with integrated access and backhaul components in accordance with some embodiments.

FIG. 3 illustrates a device in accordance with some embodiments.

FIG. 4 illustrates a packet in accordance with some embodiments.

FIG. 5 illustrates lower-layer queues of a transmitter in accordance with some embodiments.

FIG. 6 illustrates lower-layer queues of a receiver in accordance with some embodiments.

FIG. 7 illustrates lower-layer queues of a transmitter in accordance with some embodiments.

FIG. 8 illustrates lower layer queues of a receiver in accordance with some embodiments.

FIG. 9 illustrates packet data convergence protocol (PDCP) control protocol data unit (PDU) formats in accordance with some embodiments.

FIG. 10 illustrates PDCP Data PDU formats in accordance with some embodiments.

FIG. 11 illustrates an operation flow/algorithmic structure in accordance with some embodiments.

FIG. 12 illustrates another operation flow/algorithmic structure in accordance with some embodiments.

FIG. 13 illustrates an user equipment in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

Current L4S technology relies on a modified form of an explicit congestion notification (ECN) in which a congestion indication is provided in an IP header to indicate queue buildup in intermediate routers or radio links. Upon reception of a congestion indication, congestion signals may be propagated back to a sender. The signals may be sent via a transmission control protocol (TCP) ECN-echo that triggers scalable congestion control algorithms. A TCP congestion window reduced (CWR) bit may be sent back to acknowledge to the receiver that the congestion-indication echoing was received. Similar signaling may be supported on other layer 4 (L4) protocols such as QUIC.

When congestion is detected, the application server or the application may adjust the application bit rate to meet capacity of the established communication link. As a result, L4S may deliver a seamless user experience even with variable traffic load and radio conditions.

Changing the ECN bits in an IP header as a queue starts to grow to signal congestion may be referred to as marking. ECN/L4S use two least significant bits of a traffic class field in an IP version 4 (IPv4) or IP version 6 (IPv6) header to encode four different codepoints. In traditional ECN implementations, a congestion mark is equivalent to a packet drop. In L4S, the congestion mark serves as an indication instead of dropping the packet.

L4S allows relatively fine granular congestion control depending on the application (for example, with active queue management (AQM) and scalable TCP). LAS allows for improved queue utilization and better use of network resources. If applied to the radio, it may allow for better spectrum utilization. Routers or nodes using AQM may signal congestion indication upon detecting high delay or high buffer status.

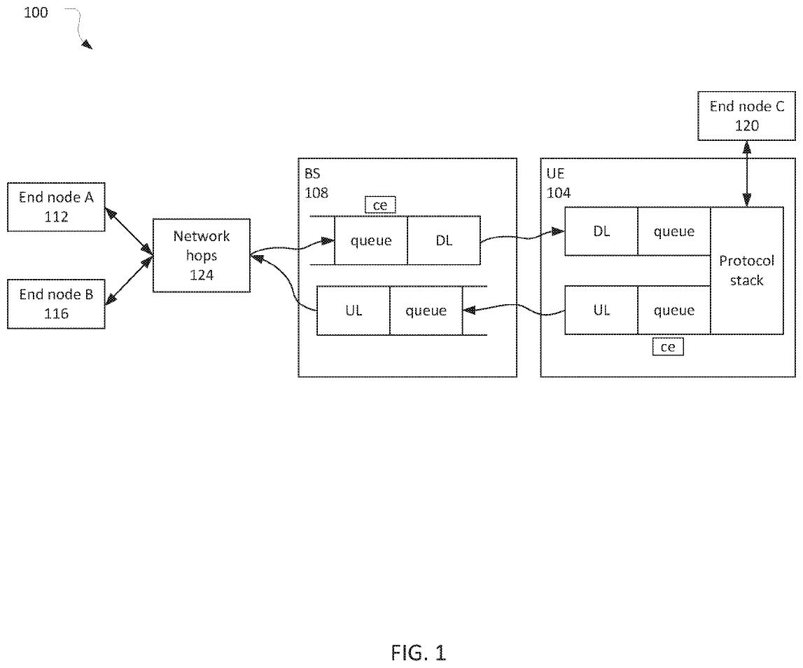

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define LTE, Fifth Generation (5G) NR, or later system standards.

The network environment 100 further includes three end nodes, end node A 112, end node B 116, and end node C 120. While shown separately in FIG. 1, end node C 120 may also be part of UE 104.

The end nodes may communicate with one another through the UE 104, RAN 108, and one or more network hops 124. The end nodes may host application layers that communicate application traffic with one another over the intervening network nodes. The network hops 124 may include hops in a RAN, core network (CN), external data network, etc.

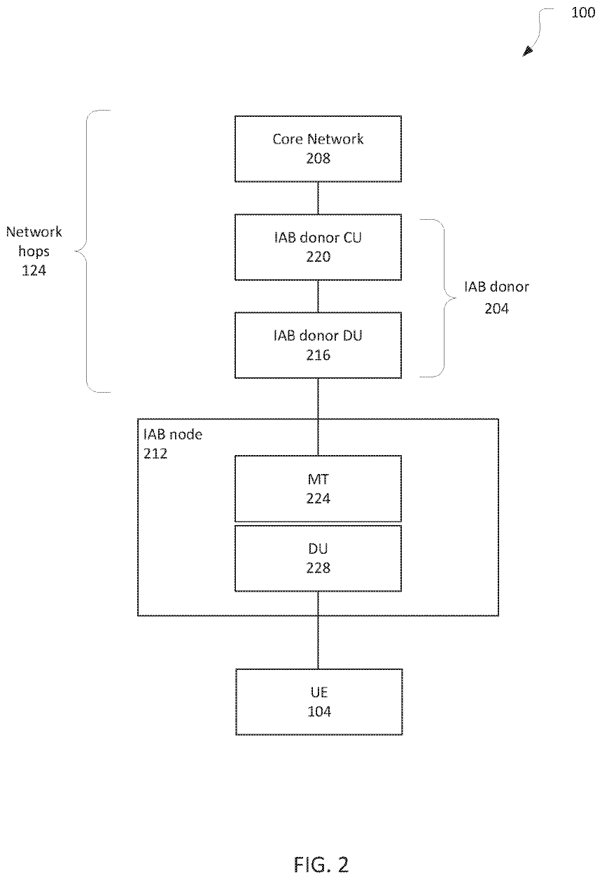

In some embodiments, the BS 108 and devices of the network hops 124 may include integrated access and backhaul (IAB) nodes that facilitate relaying of access traffic by sharing radio resources between access and backhaul links. FIG. 2 illustrates the network environment 100 implementing IAB concepts that may be used in some embodiments. In an IAB deployment, the network hops 124 may include an IAB donor 204 and core network 208. The IAB donor 204 may be a RAN node that provides an interface to the core network 208 and provides wireless backhauling functionality to an IAB node. An IAB node is a RAN node that provides the UE 104 with wireless access and wirelessly backhauls the access traffic to another IAB node or an IAB donor.

The base station 108 may correspond to a gNB or one or more of the IAB nodes (for example, IAB node 212, IAB donor 204, etc.). In some embodiments, the base station 108 may be separate from the IAB nodes and may be provided, for example, between IAB node 212 and the UE 104. The network hops 124 may include additional IAB nodes between IAB node 212 and the IAB donor 204.

The IAB donor 204 may have a distributed unit (DU) 216 and a centralized unit (CU) 220 disposed on separate devices. In general, the IAB donor CU 220 may handle higher-layer protocols, for example, radio resource control (RRC), packet data convergence (PDCP), and service data adaptation protocol (SDAP) layer protocols, while the IAB donor DU 216 may handle lower-layer protocols, for example, radio link control (RLC), media access control (MAC), and physical (PHY) layer protocols. In some embodiments, the base station 108 may provide CU and DU entities (for example, gNB-CU and gNB-DU).

The IAB node 212 may include a mobile termination (MT) 224 and a DU 228 that is coupled with the UE 104 or another IAB node. The MT 224 may be used to connect the IAB node 212 with an upstream (for example, towards the core network 208) RAN node (for example, IAB donor DU 216). In general, the MT 224 may provide the IAB node 212 with access functionality similar to a UE. For example, the MT 224 may utilize protocols that a typical UE may use to connect to a RAN. The MT 224 may, for example, allow the IAB node 212 to establish signaling radio bearers (SRBs) and/or data radio bearers (DRBs) with a parent node. The MT 224 may perform cell selection to identify an upstream RAN node to join and then set up and utilize an RLC channel through a backhaul adaptation (BAP) layer that provides functionality for routing data for different UE bearers over different routes through the network. The MT 224 may also perform, for example, cell reselection, radio-link failure, etc. In some embodiments, the IAB node to which the MT 224 connects, for example, the IAB donor 204, as shown, or another IAB node, may be considered the base station 108.

In a cellular data path architecture of the network environment 100, queuing may apply to packets in the UE 104 and the BS 108. With respect to the UE 104, to ensure layer 2 (L2)/media access control (MAC) has sufficient data available, new data from upper layers may constantly be added to the local queue. Based on anticipation of uplink grants from the BS 108, the data path may encipher and have new packets ready to be transmitted. However, due to the highly dynamic nature of wireless links in cellular networks such as 5G network at millimeter wave (mmWave) frequencies, it may be possible that throughput may drop for a sustained period of time. This may happen when the UE 104 has a non-line-of-sight (NLOS) connection with the frequency range 2 (FR2) tower. Additionally, due to sub-optimal radio conditions, the wireless link may experience retransmission of packets at several layers such as, for example, a MAC layer or a radio link control (RCL) layer. In such cases, the L2/MAC queues may experience buffer bloat. Similarly, with respect to the BS 108, packets may be queued up and waiting for scheduling opportunity and, based on the bandwidth conditions, the queues may experience buffer bloat. Embodiments of the present disclosure provide for detecting congestion at the queues of the UE 104 and BS 108. Upon detection of a congestion event, embodiments provide for setting a congestion experienced (CE) indication, which may be used to assist an application at one of the end nodes. The CE indication may be provided via ECN/L4S fields in an IP header and elsewhere as described herein.

5G NR and LTE support ECN at the IP layer where a base station and UE may insert ECN code points as specified in clause 5 of IETF request for comments (RFC) 3168, “The Addition of Explicit Congestion Notification (ECN) to IP,” September 2001. In particular, a UE and a base station may set a CE codepoint ‘11’ in a packet data convergence protocol (PDCP) service data unit (SDU) (in the IP packet). However, this means that ECN marking can only happen at the tail of the queue. Given that a UE's L2 buffer can be very large and grant-scheduling delays may exist, an ECN/L4S marking at an end of the queue may come with the disadvantage of additional delay for the CE endpoint reaching its destination. Embodiments described herein provide insertion of a CE codepoint at a head of a PDCP queue, for example, for transmission over an air interface.

In some embodiments, the applications at the end nodes may include applications for extended reality (XR) services that transmit/receive XR traffic over the network. The support of XR services require low latency and high throughput. L4S may be used to reduce latency and congestion and insured desired experience for users of XR services.

ECN/L4S is an end-to-end mechanism that depends on the capability of the transport network. It may enable faster codec rate adaptation at end points and may help to keep latency low and throughput high.

From a radio interface perspective, it may be advantageous to determine whether or not congestion exists at radio layers or other points within a 5G system. In some embodiments, congestion at an air interface may be indicated using one CE bit that is communicated to upper sublayers and translated into respective representation at an IP layer. However, to allow supportive use cases in which full end-to-end ECN/L4S consistency is desired, some embodiments may provide the CE indication with more than one bit (for example, two bits). ECN, L4S, and CE may be used interchangeably throughout this description.

Embodiments describe how a PDCP layer can support an early CE indication mechanism, in spite of the constraints given by ciphering and integrity protection. Embodiments include providing a CE indication at layer 2 over PDCP or SDAP. Some aspects include including CE codepoints via a L4S DRB, PDCP control/data PDU header formats, and early signaling of a CE indication.

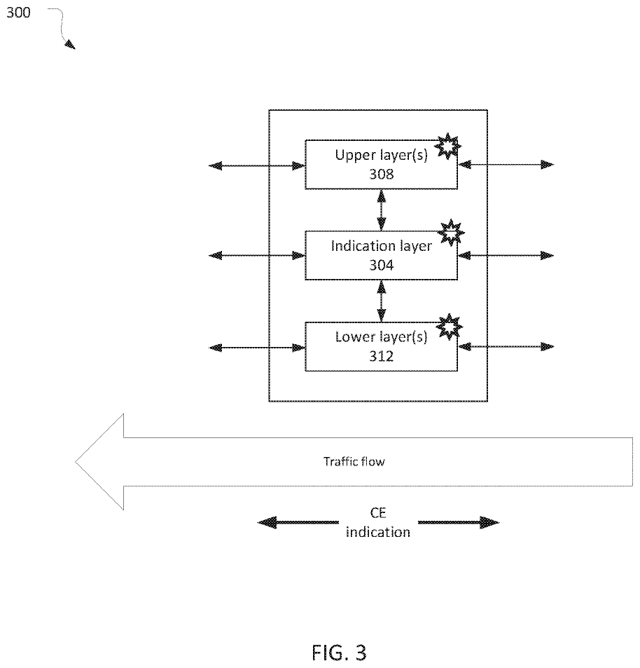

FIG. 3 shows a device 300 in accordance with some embodiments. The device 300 may be the UE 104, base station 108 (as an IAB node or distinct therefrom), or a device of the network hops 124 (for example, an IAB node/donor). The device 300 may include a number of protocol layers, shown generically as indication layer 304, upper layer(s) 308, and lower layer(s) 312. The indication layer 304 may a PDCP or SDAP layer that provides an indication of the congestion event. The upper layer(s) 308 and lower layer(s) 312 may be defined with respect to the indication layer 304.

In various embodiments, the congestion event may be detected at the indication layer 304, the upper layer(s) 308, or the lower layer(s) 312. If the congestion event is detected in the upper layer(s) 308 or the lower layer(s) 312, the detection layer may inform the indication layer 304 with a congestion indication or event, for example, in a primitive or a message.

The packets including the CE indications, which may be referred to as CE packets, may be transmitted from the indication layer 304 in the same direction as the traffic flow in which the congestion was detected, or in the opposite direction.

In some embodiments, the CE packets marked by the indication layer 304 may be transmitted through a queue that is different from the queue having the traffic flow as will be described herein.

Since PDCP is close to the IP layer and the traffic pipe (IP vs non-IP) is typically known to an implementation, a modification of CE bits in the PDCP SDU can be straightforward, either directly in PDCP implementation or by providing an indication to upper layers. As mentioned earlier, 5G NR currently relies on marking the tail of the queue (which is slow). A core function of PDCP is to perform ciphering and integrity protection, hence, PDUs at the head of the queue cannot easily be modified by inserting CE marks directly.

To address these issues, some embodiments utilize a separate (common) DRB or quality of service (QOS) flow that contains CE packets from other DRBs. Whenever congestion is detected for a DRB or QoS flow, the transmitter puts a CE packet into a “common” DRB queue (e.g., on a different DRB) that is used for the purpose of transmitting CE indications. Each individual CE packet is marked with the original DRB/QoS flow to which the CE indication applies. The common DRB may be configured with high logical channel (LCH) priority to prioritize transmission of the CE packets.

The receiver, upon reception of the CE packet and identification of the original DRB/QoS flow, may apply CE from the earliest sequence number (SN) in that queue (e.g., at the queue head) and report the same to upper layers.

The transmitter may optionally include an SN of the original DRB that has experienced congestion. In this case the receiver sets the CE indication from this SN onwards (on the respective original queue). However, it may happen that the indicated SN was already delivered to upper layers. In this case the receiver takes the next SN. The transmitter identifies an SN based on an indication from other layers. The CE packet may refer to the first packet in the respective original lower layer queue, or the next packet to be sent out on air (for example, the SN can be defined based on MAC (first packet in the TB for a grant), RLC, or PDCP).

The transmitter may use one CE packet to set a congestion condition and another CE packet to clear the congestion condition. Thus, in some embodiments, only one bit is used: CE set/clear. To protect against possible CE packet loss, as an option, the transmitter can mark more than one packet with CE set/clear for the same DRB/QoS flow. The number of marking repetitions may be fixed or dynamically defined in operation.

These and other aspects of CE signaling will be described in more detail herein.

The approach of using a separate queue for CE packets can be applied at any sublayer of L2. This approach may be especially useful at the PDCP/SDAP layer, as the RLC and MAC layers can utilize other options. The desired layer may be PDCP (if the resolution is per DRBs) or SDAP (if the resolution is per QoS flows). This has the advantage that CE packets are also integrity protected, hence, an adversary cannot insert false CE packet.

Marking on the common CE queue can be done through a control PDU or a data PDU.

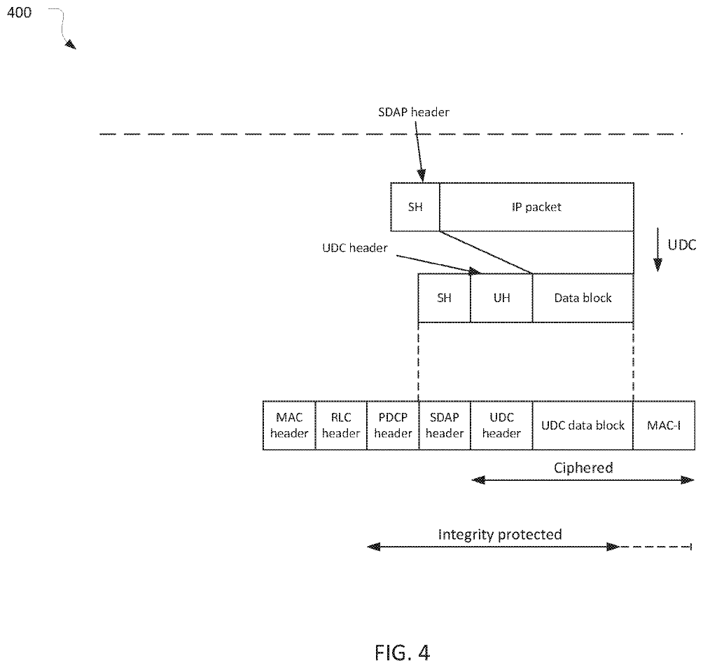

FIG. 4 illustrates a packet 400 corresponding to a PDCP data PDU in accordance with some embodiments. As shown in the packet 400, a user data convergence (UDC) header, UDC data block, and a MAC-integrity field may be ciphered and integrity protected; and the PDCP header and the SDAP header may be integrity protected but not ciphered. While PDCP data PDUs may be ciphered and integrity protected, ciphering and integrity protection may not be applicable to PDCP Control PDUs.

Whether the common CE DRB queue operates on PDCP Control PDUs or PDCP Data PDUs may depend on the desired level of security protection for the signaled parameters of the original DRB.

In some embodiments, a DRB can operate as common CE DRB, carrying the congestion indications from other DRBs. This may be done based on one or more of the following options.

In a first option, the DRB operates as standalone common DRB. The DRB carries CE packets of other DRBs or QoS flows only. The standalone common DRB may not carry non-CE packets that carry data for other traffic flows.

In a second option, the DRB is a normal DRB also operating as a common CE DRB. Such DRB may have its own traffic from associated QoS flows for normal user plane traffic, but CE packets can be carried on that DRB as well. With this option, it may be preferred that PDCP Control PDUs are used to signal the CE indication, but PDCP Data PDUs could carry the CE indication as well.

A third option may be similar to the second option; however, there may be no special association between normal and common DRBs. The transmitter can select any available DRB to transmit a CE packet. For example, in order to transmit the CE packet, the transmitter may select a DRB having characteristics that may result in a rapid transmission of the CE packet. For example, the transmitter may select a DRB having the highest LCH priority or a DRB with a low buffer state, whatever is faster and is more likely to transmit the CE packet first.

Various RRC configurations may be available to facilitate transmission of the CE packets in a separate queue. Some RRC configuration options may be described as follows.

Any DRB may be configured by RRC to act as a common CE DRB. The common CE DRB may be associated with all CE capable DRBs, which may also be referred to as “original DRBs.”

A default, or fixed, DRB may be configured or specified to act as a common CE DRB. The common CE DRB may be associated with all CE capable DRBs (original DRBs).

The association between normal/common DRBs as well as the CE DRB property on the normal DRB itself may be configured by RRC.

In some embodiments, the base station 108 may use RRC signaling to establish a mapping between one or more CE-capable original DRBs and at least one common CE DRB. For example, a first set of CE-capable original DRBs may be associated with a first common CE DRB, while a second set of CE-capable original DRBs are associated with a second common CE DRB. In some embodiments, a 1:1 mapping may be configured between an original DRB and a CE DRB.

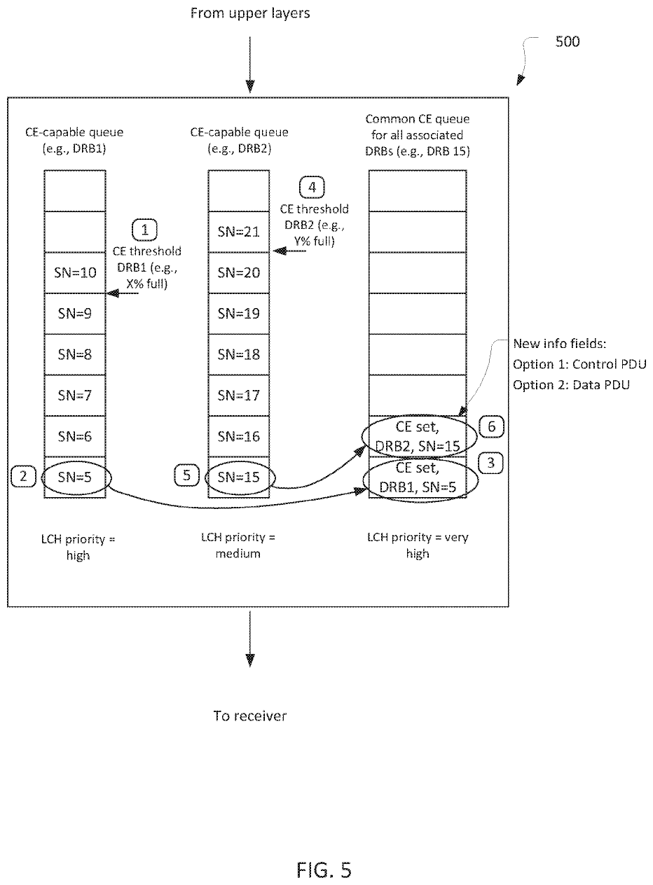

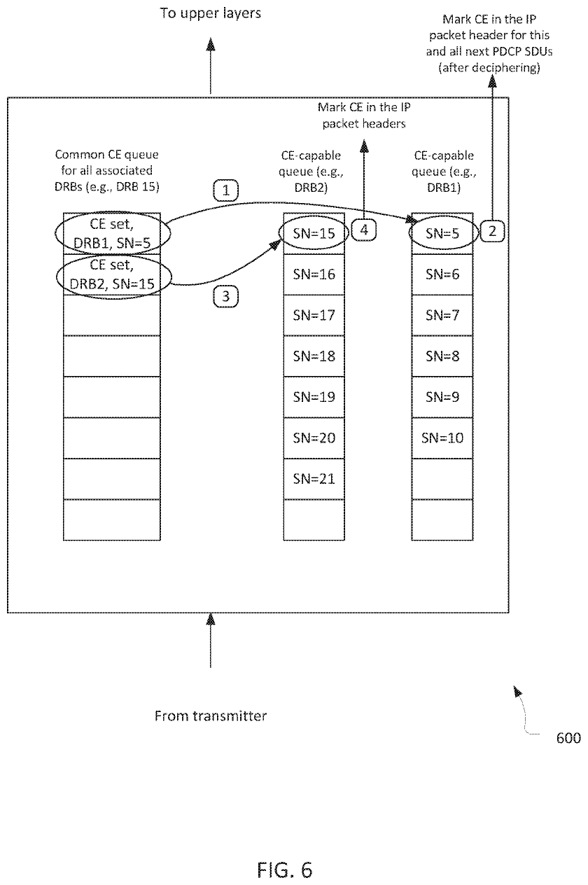

FIG. 5 illustrates lower-layer queues 500 at a transmitter and FIG. 6 illustrates lower-layer queues 600 at a receiver in accordance with some embodiments. These figures may provide an example of setting an CE-set indication (to indicate congestion is experienced) in a common CE queue. In some embodiments, the lower-layer queues 500 and 600 may be PDCP queues or SDAP queues.

With reference to FIG. 5, the lower-layer queues 500 may include a first CE-capable queue for DRB1, shown with packets having SNs 5-10, and a second CE-capable queue for DRB2, shown with packets having SNs 15-21. The two CE-capable queues may be associated with a common CE queue for DRB 15. The setting of the CE-set indications in the lower-layer queues 500 may involve six operations, labeled as 1-6 in FIG. 5.

A first operation may include determining that a CE threshold of DRB 1 has been reached. This may be referred to a detecting a congestion event in some embodiments. The CE threshold may be, for example, when the queue is X % full. This may trigger the second operation, which may include identifying a packet in the DRB1 queue having the lowest SN, e.g., SN=5. A third operation may include generating a CE packet in the common CE queue that corresponds to the packet identified in the second operation. The CE packet in the common CE queue may be generated with a CE-set indication, an identifier associated with DRB1, and an indication of the SN of the packet identified in the second operation, e.g., SN=5.

A similar set of operations may be performed with respect to the DRB2 queue. In particular, a fourth operation may include determining that a CE threshold of DRB 2 has been reached. The CE threshold may be, for example, when the queue is Y % full. Y may be the same as, or different from, X. This may trigger the fifth operation, which may include identifying a packet in the DRB2 queue having the lowest SN, e.g., SN=15. A sixth operation may include generating a CE packet in the common CE queue that corresponds to the packet identified in the fifth operation. The packet in the common CE queue may be generated with a CE-set indication, an identifier associated with DRB2, and an indication of the SN of the packet identified in the second operation, e.g., SN=15.

The CE packets of the DRB15 queue may be generated as control PDUs or data PDUs as described elsewhere herein.

As shown, the DRB1 queue may have a high LCH priority, DRB2 queue may have a medium LCH priority, and DRB15 queue may include a very high LCH priority. Due to the relative priorities of the DRB1 queue and the DRB2 queue, the CE packets corresponding to DRB1 may be placed in the DRB15 queue before the CE packets corresponding to DRB2.

With reference to FIG. 6, the lower-layer queues 600 may include a first CE-capable queue for DRB1, shown with packets having SNs 5-10, and a second CE-capable queue for DRB2, shown with packets having SNs 15-21. The two CE-capable queues may be associated with a common CE queue for DRB 15. Processing the CE packets of the common CE queue with the CE-set indications may involve four operations, labeled as 1-4 in FIG. 6.

A first operation may include identifying a CE packet in the common CE queue with a CE-set indication, an identifier associated with DRB1, and an indication of the lowest SN that was in the corresponding transmitter queue when the congestion event was detected (for example, SN=5). In a second operation, the lower layer may provide, to an upper layer, a congestion indication with respect to the corresponding packet in the DRB1 queue (for example, the SN=5 packet). The congestion indication may be, for example, provided in a primitive, event, or message designed for inter-layer signaling. The upper layer, for example, the IP layer, may then mark CE in the IP packet header for the PDCP SDU having the SN=5 packet and following PDCP SDUs. This marking may be performed after deciphering.

A similar set of operations may be performed with respect to the DRB2 queue. In particular, a third operation may include identifying a CE packet in the common CE queue with a CE-set indication, an identifier associated with DRB2, and an indication of the lowest SN that was in the corresponding transmitter queue when the congestion event was detected (for example, SN=15). In a fourth operation, the lower layer may provide, to an upper layer, a congestion indication with respect to the corresponding packet in the DRB2 queue (for example, the SN=15 packet). The congestion indication may be, for example, provided in a primitive, event, or message designed for inter-layer signaling. The upper layer, for example, the IP layer, may then mark CE in the IP packet header for the PDCP SDU having the SN=15 packet and following PDCP SDUs. This marking may be performed after deciphering.

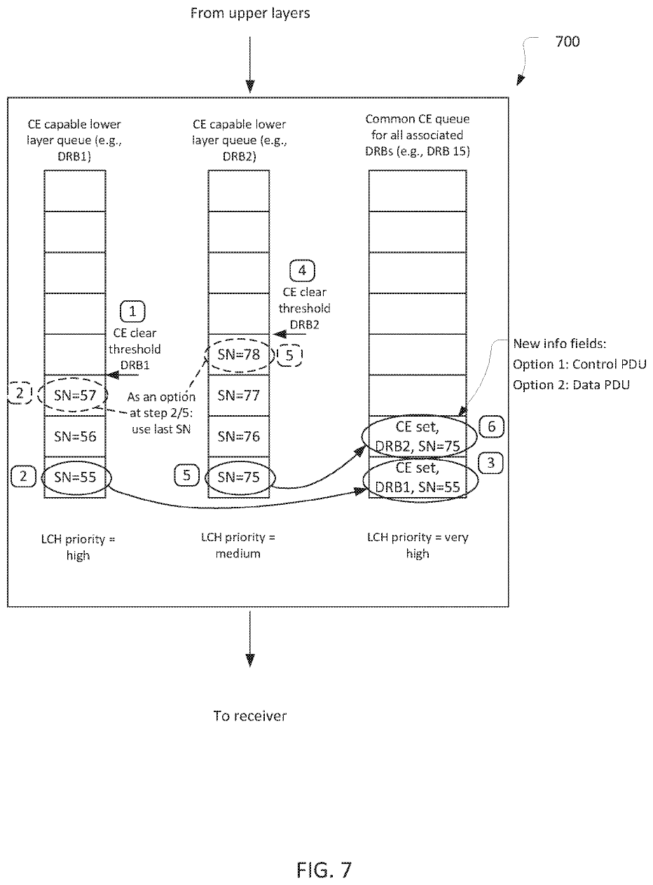

With reference to FIG. 7, the lower-layer queues 700 may include a first CE-capable queue for DRB1, shown with packets having SNs 55-57, and a second CE-capable queue for DRB2, shown with packets having SNs 75-78. The two CE-capable queues may be associated with a common CE queue for DRB 15. The setting of the CE-clear indications in the lower-layer queues 700 may involve six operations, labeled as 1-6 in FIG. 7.

A first operation may include determining that a CE-clear threshold of DRB 1 has been reached. This may be referred to a detecting a congestion event in some embodiments. The CE threshold may be, for example, when the queue is less than M % full. M may be less than X as discussed above with respect to the CE-set threshold. This may trigger the second operation, which may include identifying a packet in the DRB1 queue having the lowest SN, e.g., SN=5. In some embodiments, instead of selecting the packet with the lowest SN at the time of detecting the CE-clear congestion event, the packet in the queue having the highest SN number may be selected. A third operation may include generating a CE packet in the common CE queue that corresponds to the packet identified in the second operation. The CE packet in the common CE queue may be generated with a CE-clear indication, an identifier associated with DRB1, and an indication of the SN of the packet identified in the second operation, e.g., SN=55 (or SN=57).

A similar set of operations may be performed with respect to the DRB2 queue. In particular, a fourth operation may include determining that a CE threshold of DRB 2 bas been reached. The CE threshold may be, for example, when the queue is less than N % full. N may be the same as, or different from, M and may be less than Y as discussed above with respect to the CE-set threshold. This may trigger the fifth operation, which may include identifying a packet in the DRB2 queue having the lowest SN, e.g., SN=75 (or the highest SN, e.g., SN=78). A sixth operation may include generating a CE packet in the common CE queue that corresponds to the packet identified in the fifth operation. The packet in the common CE queue may be generated with a CE-set indication, an identifier associated with DRB2, and an indication of the SN of the packet identified in the second operation, e.g., SN=75 (or SN=78).

The CE packets of the DRB15 queue may be generated as control PDUs or data PDUs as described elsewhere herein.

As shown, the DRB1 queue may have a high LCH priority, DRB2 queue may have a medium LCH priority, and DRB15 queue may include a very high LCH priority. Due to the relative priorities of the DRB1 queue and the DRB2 queue, the CE packets corresponding to DRB 1 may be placed in the DRB15 queue before the CE packets corresponding to DRB2.

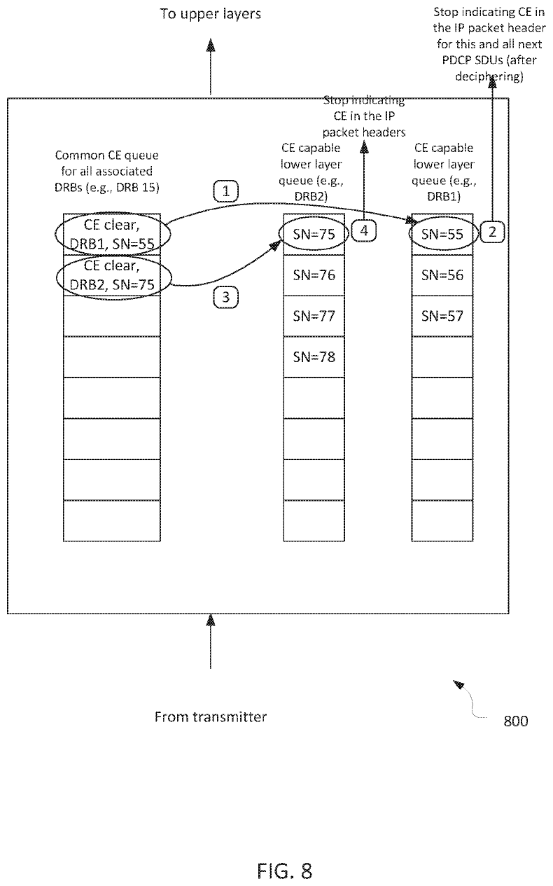

With reference to FIG. 8, the lower-layer queues 800 may include a first CE-capable queue for DRB1, shown with packets having SNs 55-57, and a second CE-capable queue for DRB2, shown with packets having SNs 75-78. The two CE-capable queues may be associated with a common CE queue for DRB 15. Processing the CE packets of the common CE queue with the CE-clear indications may involve four operations, labeled as 1-4 in FIG. 8.

A first operation may include identifying a CE packet in the common CE queue with a CE-clear indication, an identifier associated with DRB1, and an indication of the lowest SN that was in the corresponding transmitter queue when the congestion event was detected (for example, SN=55). Alternatively, as discussed above, the indication may be of the highest SN that was in the corresponding transmitter queue (for example, SN=57). In a second operation, the lower layer may provide, to an upper layer, a congestion indication with respect to the corresponding packet in the DRB1 queue (for example, the SN=55 packet). The congestion indication may be, for example, provided in a primitive, event, or message designed for inter-layer signaling. The upper layer, for example, the IP layer, may then stop marking CE in the IP packet header for the PDCP SDU having the SN=55 packet and following PDCP SDUs. The clearing of the marking may be performed after deciphering.

A similar set of operations may be performed with respect to the DRB2 queue. In particular, a third operation may include identifying a CE packet in the common CE queue with a CE-clear indication, an identifier associated with DRB2, and an indication of the lowest SN that was in the corresponding transmitter queue when the congestion event was detected (for example, SN=75). Alternatively, as discussed above, the indication may be of the highest SN that was in the corresponding transmitter queue (for example, SN=78). In a fourth operation, the lower layer may provide, to an upper layer, a congestion indication with respect to the corresponding packet in the DRB2 queue (for example, the SN=75 packet). The congestion indication may be, for example, provided in a primitive, event, or message designed for inter-layer signaling. The upper layer, for example, the IP layer, may then stop marking CE in the IP packet header for the PDCP SDU having the SN=75 packet and following PDCP SDUs. This clearing of the marking may be performed after deciphering.

While the operations of FIGS. 5-8 are described in particular sequences, these operations may be performed in other sequences in other embodiments.

Many embodiments describe congestion as existing in a binary state. For example, providing a CE-set indication to indicate congestion is present or providing a CE-clear indication to indicate congestion is absent. Other embodiments may provide for different levels of congestion being detected/signaled in similar matters.

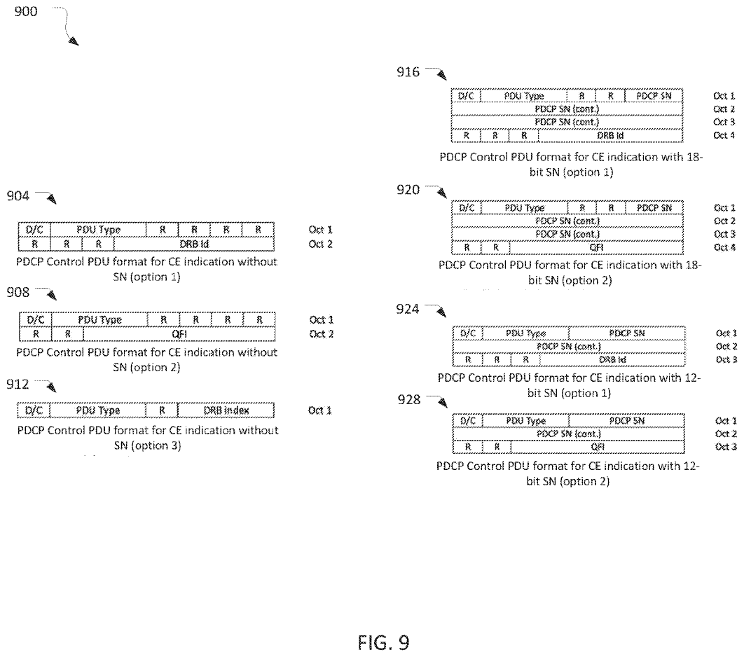

FIG. 9 illustrates examples of PDCP control PDU formats 900 for CE indications in accordance with some embodiments.

In particular, the PDCP control PDU formats 900 include three options for providing a CE indication without SN (formats 904, format 908, and format 912); two options for providing a CE indication with an 18-bit SN indication (format 916 and format 920); and two options for providing a CE indication with a 12-bit SN indication (format 924 and format 928).

Formats 904, 916, and 920 provide DRB identifiers to identify the DRB to which the CE indication relates; and formats 908, 920, and 928 provide QFIs to identify the QoS flow to which the CE indication relates. Format 912 may be a compact format (only one octet) that relies on a DRB index. In this case, RRC signaling may be used to configure up to eight DRBs for which a congestion status is to be monitored. The DRB index may be used to identify one of the DRBs configured by RRC signaling for congestion monitoring.

The transmitter may use one or more of the PDCP control PDU formats 900 to indicate a congestion status for a DRB/QoS flow. Out of the bits marked “R” either one bit is used as a CE set/clear indication or two bits are used for a two-bit indication. In some embodiments, the two bits may correspond to codepoints according to ECN codepoints shown in Table 1 or LAS codepoints shown in Table 2 below.

TABLE 1

| Binary codepoint | Codepoint name | Meaning |
|---|---|---|
| 00 | Not-ECT | Not ECN-capable transport |
| 01 | ECT(1) | ECN-capable transport |
| 10 | ECT(0) | ECN-capable transport |
| 11 | CE | Congestion experienced |

TABLE 2

| Binary codepoint | Codepoint name | Meaning |
|---|---|---|
| 00 | Not-ECT | Not ECN-capable transport |
| 01 | ECT(1) | L4S-capable transport |
| 10 | ECT(0) | Not L4S capable transport |
| 11 | CE | Congestion experienced |

These codepoints may be similar to those described in IETF RFC 3168.

Upon reception of a CE indication in a PDU with no SN (for example, format 904, 908, or 912), the receiver may apply CE from the first SN currently in the queue. This may correspond to the next SN delivered to upper layers.

Upon reception of a CE indication in a PDU with SN, the receiver may apply CE from the indicated SN onwards, for all following SNs.

Table 3 below illustrates codepoints for a PDU type field in accordance with some embodiments. Table 3 illustrates an example allocation of the PDU type field with respect to PDCP control PDU formats of FIG. 9. The PDU type field may have a length of three bits and may indicate a type of control information included in the corresponding PDCP control PDU.

TABLE 3

| Bit | Description |
|---|---|
| 000 | PDCP status report |
| 001 | Interspersed ROCH feedback |
| 010 | EHC feedback |
| 011 | UDC feedback |
| 100 | PDCP Control PDU format for CE indication with no SN |
| 101 | PDCP Control PDU format for CE indication with 12 bits SN |
| 110 | PDCP Control PDU format for CE indication with 18 bits SN |
| 111 | Reserved |

Some embodiments may provide a PDCP data PDU with separate CE queue for CE indications.

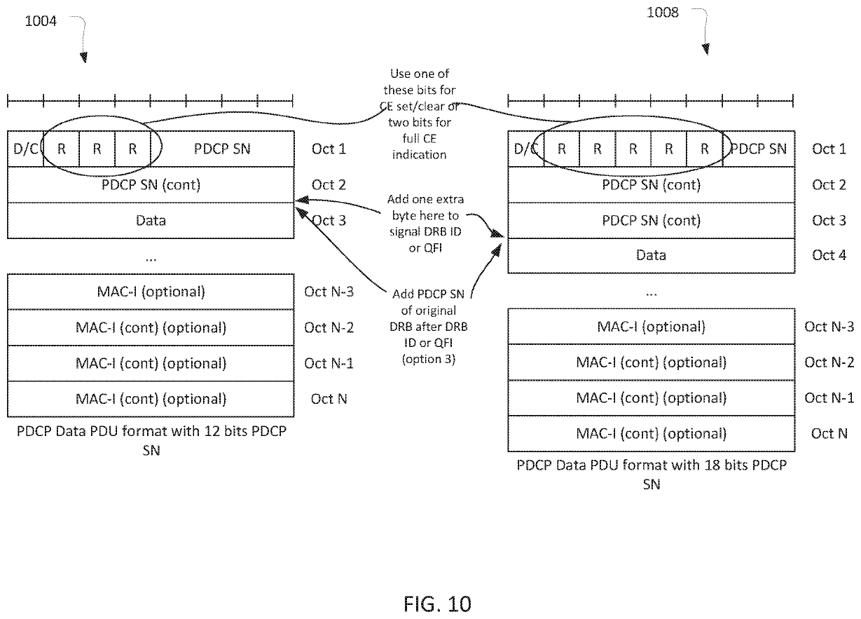

FIG. 10 illustrates PDCP Data PDU formats 1000 associated with a common CE queue in accordance with some embodiments. In particular, FIG. 10 illustrates format 1004, which is a PDCP data PDU format with 12-bits for the PDCP SN and format 1008, which is a PDCP data PDU format with 18-bits for the PDCP SN. Formats 1004 and 1008 may be used in accordance with one or more of the following options.

In a first option, an SN represents the normal SN of the common CE DRB queue, not the SN of the original DRB queue. Upon reception of such a PDU the receiver simply marks CE on the original DRB Id (or for the QoS flow indicated in the packet) from the highest/earliest PDU onwards (e.g. the head of that receive queue, or the next PDU delivered to upper layers). Only one SN is present in the PDCP Data PDU.

In a second option, the SN represents the SN of the original DRB queue. In this option the common CE queue does not have a traditional PDCP SN (for example, its own SN). In other words, PDCP operates out-of sequence all the time. PDCP out-of-order delivery may be a prerequisite in this embodiment. Only one SN may be present in the PDCP Data PDU.

In a third option, a data PDU contains two SNs, the normal one from the common CE DRB and the indicated SN from the original DRB.

Some operational aspects of the CE DRB may be considered as follows.

Information from the original DRB may be inserted as PDCP header content. This implies the information is not ciphered but integrity protected.

If full protection (including ciphering) of inserted content is desired, then those header fields may be moved into a separate CE header that is defined to be part of the PDCP Data field.

As information of the original DRB may be contained in header fields, the data field of the common CE DRB may support normal (non-CE) DRB user data as well, otherwise the data field on this DRB would be empty or contain dummy data.

In some embodiments, upper layer indications may be provided as follows. On the common CE queue, if a received PDCP Data PDU or a received PDCP Control PDU includes a CE indication (CE set/clear as one bit or a two-bit indication) the PDCP entity may deliver the information to upper layers. Additionally/alternatively, the PDCP entity may modify the respective IP header field in the PDCP SDU directly.

In some embodiments, CE marking may be provided through separate CE queue for SDAP PDUs for common QoS flows. These embodiments may use a common QoS flow, which carries CE feedback from other QoS flows (similar to the PDCP design). Assuming SDAP does not rely on the optional indication of sequence numbers from the original QoS flow, then SDAP control PDUs or SDAP data PDUs can be defined in UL and DL. Those new SDAP control and data PDUs may carry the following additional parameters: one bit CE set/clear or a two-bits CE indication; 6 bits for the QFI or the original QoS flow (to be piggy-backed) on the common QoS flow. The rest of the principles may be similar the PDCP embodiments described elsewhere.

Some advantages of piggy-backing CE indication on a separate common DRB or QoS flow are as follows.

Embodiments allow for transmission of radio related congestion information between UE and a network node even if one or more hops are between the UE and the network node. For example, a UE may signal radio-related congestion information to a gNB-CU regardless of how many gNB-DU hops are in between when IAB is deployed in the network. In some embodiment, the congestion signaling may be transparent to the gNB-DU, which may not need modification of gNB-DU implementation.

Depending on whether the deployment of the common CE queue is over a DRB or over a dedicated QoS flow (in PDCP or SDAP), if a common QoS flow is designated for transmission of congestion information, the information can be transmitted directly between the UE and the UPF. In order to do so, the N3 interface may need to be enhanced to carry the congestion information inserted to the designated QoS flow. Furthermore, other interfaces may be updated to accommodate the congestion signaling including, for example, the N2 interface between the RAN and an access and mobility function (AMF).

In some embodiments, a common CE DRB may be configured with separate QoS properties. For example, the common CE DRB may be set with parameters to provide PDCP duplication, TB repetition, high reliability, low latency (fast scheduling policies), or high LCH priority as desired for CE signaling.

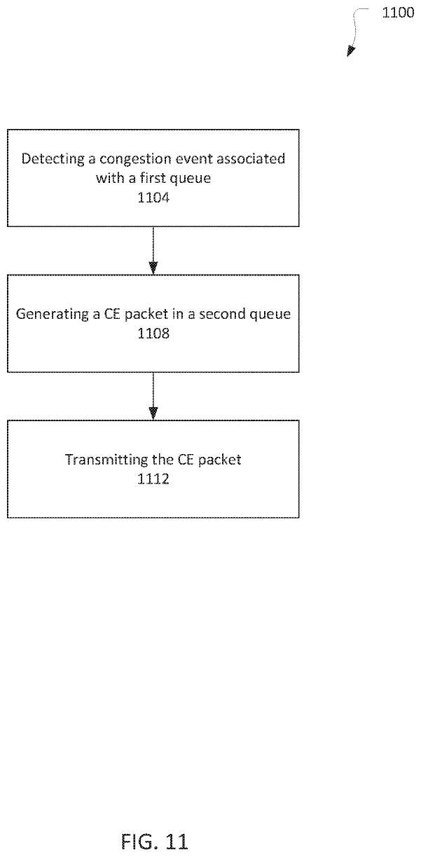

FIG. 11 is an operation flow/algorithmic structure 1100 in accordance with some embodiments. The operation flow/algorithmic structure 1100 may be implemented by a transmitter included in a UE (for example, UE 104 or UE 1300), or a network node (for example, BS 108, IAB node 212, IAB donor 204, or network node 1400) or components therein, for example, processing circuitry 1304 or 1404.

The operation flow/algorithmic structure 1100 may include, at 1104, detecting a congestion event associated with a first queue. In some embodiments, the transmitter may detect the congestion event based on an amount of packets in the first queue. For example, if the first queue is utilized more than a first predetermined threshold, the transmitter may determine that congestion is present. Utilization may be based on percentage of the buffer that is being used or an amount of data in the buffer. Conversely, if the buffer is utilized less than a second predetermined threshold, the transmitter may detect a congestion event related to congestion being absent.

The first queue may be for a DRB or QoS flow and may include PDCP SDUs, PDCP PDUs, SDAP SDUs, or SDAP PDUs.

In some embodiments, the transmitter may detect the congestion event based on other parameters associated with traffic of the first queue. These parameters may include a delay budget, a round-trip-time (RTT), a number of experienced retransmissions or missing acknowledgments, etc.

The operation flow/algorithmic structure 1100 may further include, at 1108, generating a CE packet in a second queue. The CE packet may include a CE indication and an identifier associated with the first queue. The CE indication may be a CE-set indication to indicate the traffic flow of the first queue is experiencing congestion, or it may be a CE-clear indication to indicate the traffic flow is not experiencing congestion.

In some embodiments, the CE packet may be a PDCP control PDU that includes a PDU type field. The PDU type field may indicate whether the PDU has a format for congestion feedback with no sequence number, a format for congestion feedback with 12-bit sequence number, or a format for congestion feedback with 18-bit sequence number.

In some embodiments, the CE packet may be a PDCP data PDU. The PDCP data PDU may include a sequence number associated with the first queue, a sequence number associated with the second queue, or sequence numbers associated with both the first queue and the second queue.

The second queue may be configured to carry CE packets associated with the first queue and, potentially, one or more other queues. In some embodiments, the second queue may be specifically configured to carry CE packets. In other embodiments, the second queue may carry both CE packets and non-CE packets. If the device implementing the operation flow/algorithmic structure 1100 is a UE, the configuration of the second queue including, for example, association of the second queue with the first queue and, potentially, one or more other queues, may be provided by RRC signaling from a base station.

The operation flow/algorithmic structure 1100 may further include, at 1112, transmitting the CE packet. The CE packet may be transmitted with a relatively high priority. This may be accomplished by, for example, providing the second queue with an LCH priority higher than that of the first queue.

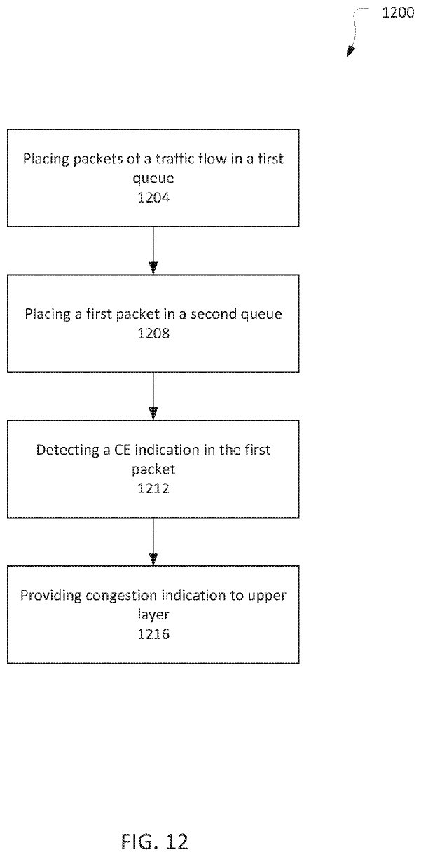

FIG. 12 is an operation flow/algorithmic structure 1200 in accordance with some embodiments. The operation flow/algorithmic structure 1200 may be implemented by a receiver included in a UE (for example, UE 104 or UE 1300), or a network node (for example, BS 108, IAB node 212, IAB donor 204, or network node 1400) or components therein, for example, processing circuitry 1304 or 1404.

The operation flow/algorithmic structure 1200 may include, at 1204, placing packets of a traffic flow in a first queue. The packets may be PDCP PDUs, PDCP SDUS, SDAP PDUs, or SDAP SDUs.

The operation flow/algorithmic structure 1200 may further include, at 1208, placing a first packet in a second queue. The second queue may be configured to carry CE indications for the first queue and, potentially, one or more other queues.

The operation flow/algorithmic structure 1200 may further include, at 1212, detecting a CE indication in the first packet. The receiver may determine that the first packet corresponds to the first queue based on an identifier (for example, a DRB identifier, a DRB index, or a QFI) in the first packet. The CE indication may be a CE-set indication to indicate the traffic flow of the first queue is experiencing congestion, or it may be a CE-clear indication to indicate the traffic flow is not experiencing congestion.

The operation flow/algorithmic structure 1200 may further include, at 1216, providing a congestion indication to an upper layer. In some embodiments, the upper layer may be an IP layer that begins to mark CE (or clear CE) in the IP packet header(s) for PDCP SDU(s) from the first queue.

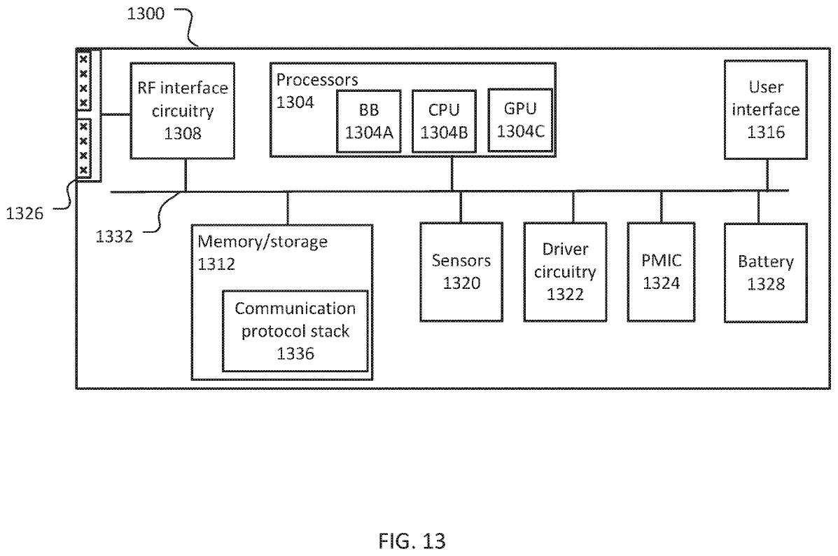

FIG. 13 illustrates a UE 1300 in accordance with some embodiments. The UE 1300 may be similar to and substantially interchangeable with UE 134 of FIG. 1.

The UE 1300 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1300 may include processors 1304, RF interface circuitry 1308, memory/storage 1312, user interface 1316, sensors 1320, driver circuitry 1322, power management integrated circuit (PMIC) 1324, antenna structure 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack 1336 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein. The memory/storage 1312 include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various I/O devices that may be present within, or connected to, the UE 1300. For example, the driver circuitry 1312 may include circuitry to facilitate coupling of a UICC (for example, UICC 138) to the UE 1300. For additional examples, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300 including DRX as discussed herein.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

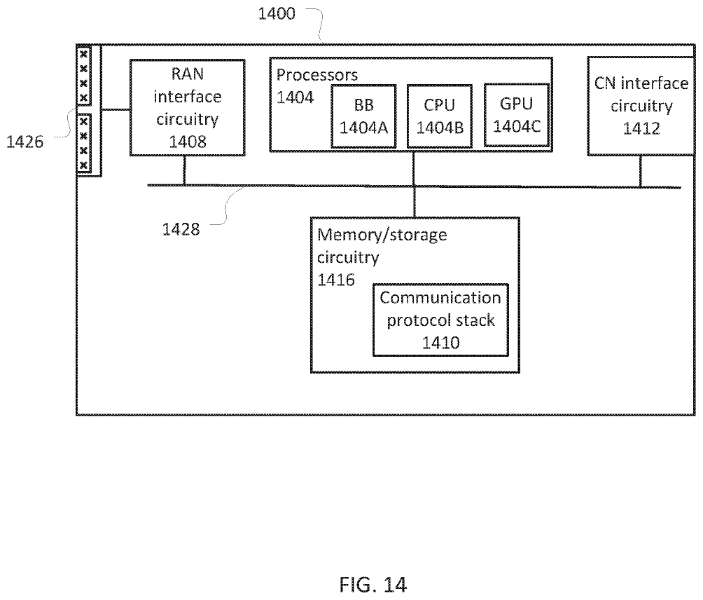

FIG. 14 illustrates a network node 1400 in accordance with some embodiments. The network node 1400 may be similar to and substantially interchangeable with base station 108, a device implementing one of the network hops 124, a network-controlled repeater, or a server in a core network or external data network.

The network node 1400 may include processors 1404, RF interface circuitry 1408 (if implemented as an access node), core network (CN) interface circuitry 1412, memory/storage circuitry 1416, and antenna structure 1426.

The components of the network node 1400 may be coupled with various other components over one or more interconnects 1428.

The processors 1404, RF interface circuitry 1408, memory/storage circuitry 1416 (including communication protocol stack 1410), antenna structure 1426, and interconnects 1428 may be similar to like-named elements shown and described with respect to FIG. 13.

The CN interface circuitry 1412 may provide connectivity to a core network, for example, a 5th Generation Core network (5GC) using a 5GC-compatible network interface protocol such as carrier Ethernet protocols, or some other suitable protocol. Network connectivity may be provided to/from the network node 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

In some embodiments, the network node 1400 may be coupled with transmit receive points (TRPs) using the antenna structure 1426, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a first device, the method comprising: detecting a congestion event associated with a first traffic flow in a first queue; generating, in a second queue, a packet with a congestion experienced (CE) indication and an identifier associated with the first queue; and transmitting the packet. The device may be a UE, base station, network hop device (e.g., an IAB-DU, an IAB-MT, a network-controlled repeater, an IAB-CU, a gNB-DU, a gNB-CU), server, etc.

Example 2 includes the method of example 1 or some other example herein, wherein the first queue is for a first data radio bearer (DRB) or quality of service (QOS) flow and the second queue is for a second DRB or QoS flow.

Example 3 includes method of example 2 or some other example herein, wherein the second queue is for a second DRB or QoS flow that is dedicated to congestion feedback or includes both congestion feedback and non-congestion related data.

Example 4 includes a method of example 1 or some other example herein, wherein the method further comprises: determining a lowest sequence number (SN) in the first queue at a time in which the congestion event is detected; and generating the packet with an indication of the lowest SN.

Example 5 includes the method of example 1 or some other example herein, wherein the CE indication is a CE-set indication to indicate the traffic flow is experiencing congestion or a CE-clear indication to indicate the traffic flow is not experiencing congestion.

Example 6 includes a method of example 5 or some other example herein, wherein the packet is a first packet, the congestion event is a first congestion event associated with a first threshold of the first queue, the CE indication is a first CE indication that is a CE-set indication to indicate the traffic flow is experiencing congestion and the method further comprises: detecting a second congestion event associated with a second threshold of the first queue; generating, in the second queue, a second packet with a CE-clear indication to indicate the traffic flow is not experiencing congestion; and transmitting the second packet.

Example 7 includes the method of example 1 or some other example herein, wherein the first queue and the second queue are for: packet data convergence protocol (PDCP) service data units (SDUs); PDCP protocol data units (PDUs); service data adaptation protocol (SDAP) SDUs; or SDAP PDUs.

Example 8 includes method of example 1 or some other example herein, wherein the packet is a first packet and the method further comprises: generating, in the second queue, a second packet with a CE indication and an identifier associated with the third queue.

Example 9 includes the method of example 1 or some other example herein, further comprising: receiving, in radio resource control (RRC) signaling, configuration information to configure the second queue for congestion feedback and associate the second queue with the first queue.

Example 10 includes a method of example 1 or some other example herein, wherein the packet is a packet data convergence protocol (PDCP) control protocol data unit (PDU) and the method further comprises: providing, within a PDU type field of the PDCP control PDU, an indication that the packet has: a format for congestion feedback with no sequence number; a format for congestion feedback with 12-bit sequence number; or a format for congestion feedback with 18-bit sequence number.

Example 14 includes the method of example 1 or some other example herein, wherein the packet is a packet data convergence protocol (PDCP) data protocol data unit (PDU) and the method further comprises: providing, within the PDCP data PDU, a sequence number associated with the first queue, a sequence number associated with the second queue, or sequence numbers associated with both the first queue and the second queue.

Example 12 includes a method of operating a first device, the method comprising: placing a plurality of packets of a traffic flow in a first queue; placing a first packet in a second queue; detecting, in the first packet, a congestion experienced (CE) indication and an identifier associated with the first queue; and processing one or more packets of the plurality of packets based on detecting the CE indication in the first packet. The device may be a UE, base station, network hop device (e.g., an IAB-DU, an IAB-MT, a network-controlled repeater, an IAB-CU, a gNB-DU, a gNB-CU), server, etc.

Example 13 includes the method of example 12 or some other example herein, wherein the first queue is associated with a first data radio bearer (DRB) or quality of service (QoS) flow and the second queue is associated with a second DRB or QoS flow.

Example 14 includes the method of example 12 or some other example herein, wherein the CE indication is a CE-set indication to indicate the traffic flow is experiencing congestion or a CE-clear indication to indicate the traffic flow is not experiencing congestion.

Example 15 includes the method of example 12 or some other example herein, wherein the one or more packets are packet data convergence protocol (PDCP) service data units (SDUs) or service data adaptation protocol (SDAP) SDUs and processing the one or more packets comprises: generating an IP packet having a header with a CE bit and at least one packet of the one or more packets.

Example 16 includes the method of example 12 or some other example herein, wherein the second queue is associated with a data radio bearer and the first device comprises a base station centralized unit.

Example 17 includes the method of example 12 or some other example herein, wherein the second queue is associated with a quality of service flow and the first device comprises a user plane function (UPF) in a core network.

Example 18 includes the method of example 12 or some other example herein, wherein the second packet comprises a packet data convergence protocol (PDCP) data/control protocol data unit (PDU) and the method further comprises: decoding a PDU type field of the PDCP data/control PDU to obtain an indication that the second packet has: a format for congestion feedback with no sequence number; a format for congestion feedback with 12-bit sequence number; or a format for congestion feedback with 18-bit sequence number

Example 19 includes a method of operating a base station, the method comprising: generating radio resource control (RRC) message to include configuration information to configure a first queue of a user equipment for congestion feedback for data transmitted through a second queue of the user equipment; and transmitting the RRC message to the UE.

Example 20 includes the method of example 19 or some other example herein, wherein the first queue is for a first data radio bearer (DRB) or QoS flow, the second queue is for a second DRB or Qos flow, and the configuration information is further to configure the first DRB or Qos flow for congestion feedback for a plurality of DRBs or Qos flows, including the second DRB or Qos flow.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-21. (canceled)

22. A method comprising:
detecting a congestion event associated with a traffic flow in a first queue;
generating, in a second queue, a packet with a congestion experienced (CE) indication and an identifier associated with the first queue; and
outputting the packet for transmission.

23. The method of claim 22, wherein the first queue is for a first data radio bearer (DRB) or quality of service (QOS) flow and the second queue is for a second DRB or QoS flow that is dedicated to congestion feedback or includes both congestion feedback and non-congestion related data.

24. The method of claim 22, wherein the method further comprises:
determining a lowest sequence number (SN) in the first queue at a time in which the congestion event is detected; and
generating the packet with an indication of the lowest SN.

25. The method of claim 22, wherein the CE indication is a CE-set indication to indicate the traffic flow is experiencing congestion or a CE-clear indication to indicate the traffic flow is not experiencing congestion.

26. The method of claim 25, wherein the packet is a first packet, the congestion event is a first congestion event associated with a first threshold of the first queue, the CE indication is a first CE indication that is a CE-set indication to indicate the traffic flow is experiencing congestion and the method further comprises:
detecting a second congestion event associated with a second threshold of the first queue;
generating, in the second queue, a second packet with a CE-clear indication to indicate the traffic flow is not experiencing congestion; and
outputting the second packet for transmission.

27. The method of claim 22, wherein the first queue and the second queue are for: packet data convergence protocol (PDCP) service data units (SDUs); PDCP protocol data units (PDUs); service data adaptation protocol (SDAP) SDUs; or SDAP PDUs.

28. The method of claim 22, wherein the packet is a first packet and the method further comprises:
generating, in the second queue, a second packet with a CE indication and an identifier associated with a third queue.

29. The method of claim 22, further comprising:
receiving, in radio resource control (RRC) signaling, configuration information to configure the second queue for congestion feedback and associate the second queue with the first queue.

30. The method of claim 22, wherein the packet is a packet data convergence protocol (PDCP) control protocol data unit (PDU) and the method further comprises:
providing, within a PDU type field of the PDCP control PDU, an indication that the packet has: a format for congestion feedback with no sequence number; a format for congestion feedback with 12-bit sequence number; or a format for congestion feedback with 18-bit sequence number.

31. The method of claim 22, wherein the packet is a packet data convergence protocol (PDCP) data protocol data unit (PDU) and the method further comprises:
providing, within the PDCP data PDU, a sequence number associated with the first queue, a sequence number associated with the second queue, or sequence numbers associated with both the first queue and the second queue.

32. One or more non-transitory, computer-readable media having instructions that, when executed, cause processor circuitry to:
place a plurality of packets of a traffic flow in a first queue;
place a first packet in a second queue;
detect, in the first packet, a congestion experienced (CE) indication and an identifier associated with the first queue; and
provide, from a first layer to a second layer above the first layer, a congestion indication corresponding to one or more packets of the plurality of packets based on detecting the CE indication in the first packet.

33. The one or more non-transitory, computer-readable media of claim 32, wherein the first queue is associated with a first data radio bearer (DRB) or quality of service (QOS) flow and the second queue is associated with a second DRB or QoS flow.

34. The one or more non-transitory, computer-readable media of claim 32, wherein the CE indication is a CE-set indication to indicate the traffic flow is experiencing congestion or a CE-clear indication to indicate the traffic flow is not experiencing congestion.

35. The one or more non-transitory, computer-readable media of claim 32, wherein the one or more packets are packet data convergence protocol (PDCP) service data units (SDUs) or service data adaptation protocol (SDAP) SDUs and to process the one or more packets the processor circuitry is to:
generate an IP packet having a header with a CE bit and at least one packet of the one or more packets.

36. The one or more non-transitory, computer-readable media of claim 32, wherein the second queue is associated with a data radio bearer and the processor circuitry is associated with a base station centralized unit.

37. The one or more non-transitory, computer-readable media of claim 32, wherein the second queue is associated with a quality of service flow and the processor circuitry is associated with a user plane function (UPF) in a core network.

38. The one or more non-transitory, computer-readable media of claim 32, wherein the first packet is a packet data convergence protocol (PDCP) data protocol data unit (PDU) that includes a sequence number associated with the first queue, a sequence number associated with the second queue, or sequence numbers associated with both the first queue and the second queue.

39. The one or more non-transitory, computer-readable media of claim 32, wherein the first packet comprises a packet data convergence protocol (PDCP) control protocol data unit (PDU) and the instructions, when executed, further cause the processor circuitry to:
decode a PDU type field of the PDCP control PDU to obtain an indication that the first packet has:
a format for congestion feedback with no sequence number;
a format for congestion feedback with a 12-bit sequence number; or
a format for congestion feedback with an 18-bit sequence number.

40. An apparatus comprising:
processor circuitry to:
generate radio resource control (RRC) message to include configuration information to configure a first queue of a user equipment for congestion feedback for data transmitted through a second queue of the user equipment; and
output the RRC message for transmission to a user equipment; and
interface circuitry coupled with the processor circuitry to enable communication.

41. The apparatus of claim 40, wherein the first queue is for a first data radio bearer or QoS flow, the second queue is for a second DRB or QoS flow, and the configuration information is further to configure the first DRB or QoS flow for congestion feedback for a plurality of DRBs or QoS flows, including the second DRB or QoS flow.
